(19) United States
(12) Patent Application Publication
(10) Pub. No.: US 2004/0069272 A1
(43) Pub. Date: Apr. 15, 2004

(54) Displacement on demand torque smoothing using engine speed control

(76) Inventors: Jeffrey James Allen, Brighton, MI (US); Thomas Eugene Bolander, Flint, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/268,829

(22) Filed: Oct. 10, 2002

(51) Int. Cl. F02P 5/00

(52) U.S. Cl. 123/406.23; 123/481

(57) ABSTRACT

An engine control system in a vehicle including a variable displacement internal combustion engine, a speed sensor for detecting the speed of the variable displacement internal combustion engine, a controller for controlling the displacement of the variable displacement internal combustion engine, and where the controller varies the spark timing of the variable displacement engine based upon the detected speed during changes in the displacement of the variable displacement internal combustion engine.

### TECHNICAL FIELD

The present invention relates to the control of internal combustion engines. More specifically, the present invention relates to a method and apparatus to control a variable displacement internal combustion engine.

### BACKGROUND OF THE INVENTION

Present regulatory conditions in the automotive market have led to an increasing demand to improve fuel economy and reduce emissions in present vehicles. These regulatory conditions must be balanced with the demands of a consumer for high performance and quick response for a vehicle. Variable displacement internal combustion engines (ICEs) provide for improved fuel economy, as compared to fixed displacement ICEs, and torque on demand by operating on the principal of cylinder deactivation (also referred to as displacement on demand). During operating conditions that require high output torque, every cylinder of a variable displacement ICE is supplied with fuel and air to provide torque for the ICE. During operating conditions at low speed, low load, and/or other inefficient conditions for a fully displaced ICE, cylinders may be deactivated to improve fuel economy for the variable displacement ICE and vehicle. For example, in the operation of a vehicle equipped with an eight-cylinder variable displacement ICE, fuel economy will be improved if the ICE is operated with only four cylinders during low torque operating conditions by reducing throttling losses. Throttling losses, also known as pumping losses, are the extra work that an ICE must perform to pump air from the relatively low pressure of an intake manifold, across a throttle body or plate, through the ICE and out to the atmosphere. The cylinders that are deactivated will not allow air flow through their intake and exhaust valves, reducing pumping losses by forcing the ICE to operate at a higher intake manifold pressure. Since the deactivated cylinders do not allow air to flow, additional losses are avoided by operating the deactivated cylinders as “air springs” due to the compression and decompression of the air in each deactivated cylinder.

During the reactivation process, when formerly deactivated cylinders are provided with air and fuel, a torque lag may occur. The reactivated cylinders may not return to their normal reactivation torque values, creating torque disturbances in the operation of the variable displacement engine. Under nominal conditions, it is possible to predict the combination of throttle position, fuel, and spark needed to generate a smooth torque output for the ICE during deactivation and reactivation of cylinders. However, changing environmental conditions, part variation, fuel variation, accessory load issues, and other unpredictable factors may affect the brake torque of the ICE.

### SUMMARY OF THE INVENTION

The present invention is a method and apparatus for the control of cylinder deactivation in a variable displacement engine to control the torque output of cylinders upon their deactivation and reactivation.

### BRIEF DESCRIPTION OF THE DRAWINGS

FIG. 1 is a diagrammatic drawing of the control system of the present invention,

FIG. 2 is a control block diagram for the preferred control method of the present invention.

FIG. 3 is a plot of an example of a timing diagram that the control follows.

### DESCRIPTION OF THE PREFERRED EMBODIMENT

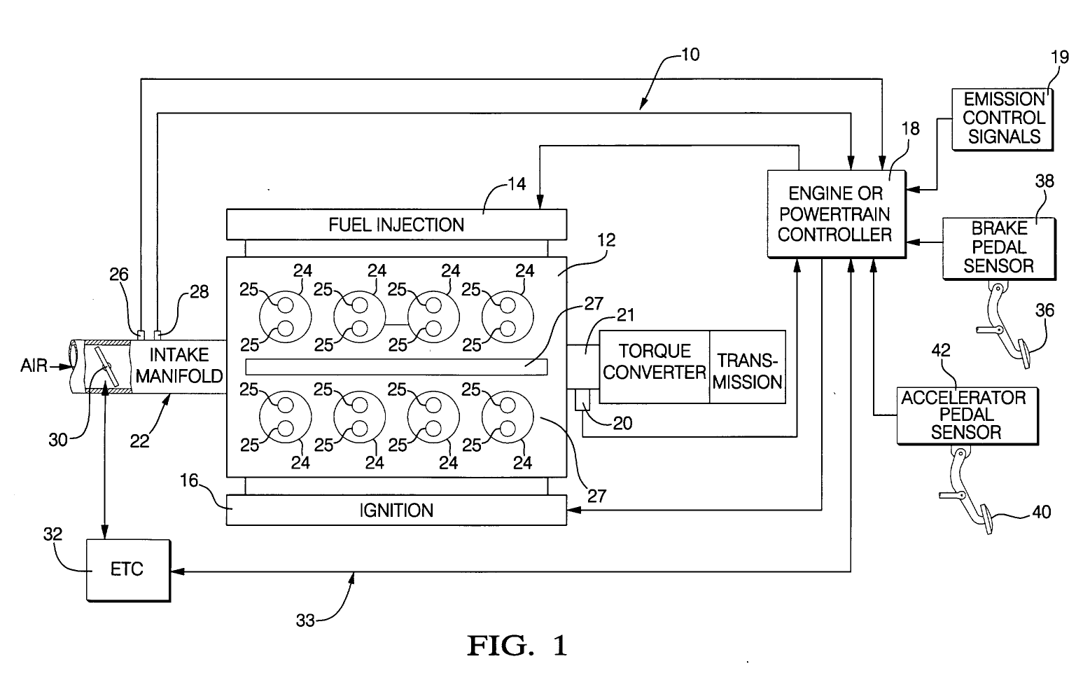

FIG. 1 is a diagrammatic drawing of the vehicle control system 10 of the present invention. The control system 10 includes a variable displacement ICE 12 having fuel injectors 14 and spark plugs 16 (in the case of a gasoline engine) controlled by an engine or powertrain controller 18. The ICE 12 crankshaft 21 speed and position are detected by a speed and position detector 20 that generates a signal such as a pulse train to the engine controller 18. The crankshaft is further coupled to a transmission 42 including a torque converter 44.

The ICE 12 may comprise a gasoline ICE or any other ICE known in the art. An intake manifold 22 provides air to the cylinders 24 of the ICE 10, the cylinders having valves 25. The valves 25 are further coupled to an actuation apparatus such as used in an overhead valve (OHV) or overhead cam (OHC) engine configuration that may be physically coupled and decoupled to the valves 25 to shut off air flow through the cylinders 24. An air flow sensor 26 and manifold air pressure (MAP) sensor 28 detect the air flow and air pressure within the intake manifold 22 and generate signals to the powertrain controller 18. The airflow sensor 26 is preferably a hot wire anemometer and the MAP sensor 28 is preferably a strain gauge.

An electronic throttle 30 having a throttle plate controlled by an electronic throttle controller 32 controls the amount of air entering the intake manifold 22. The electronic throttle 30 may utilize any known electric motor or actuation technology in the art including, but not limited to, DC motors, AC motors, permanent magnet brushless motors, and reluctance motors. The electronic throttle controller 32 includes power circuitry to modulate the electronic throttle 30 and circuitry to receive position and speed input from the electronic throttle 30. In the preferred embodiment of the deactivation in a variable displacement engine. Speed control may be substituted for torque control during this time period. The present invention utilizes speed feedback generated by sensor 20 to modify spark timing to control engine speed in the ICE 12.

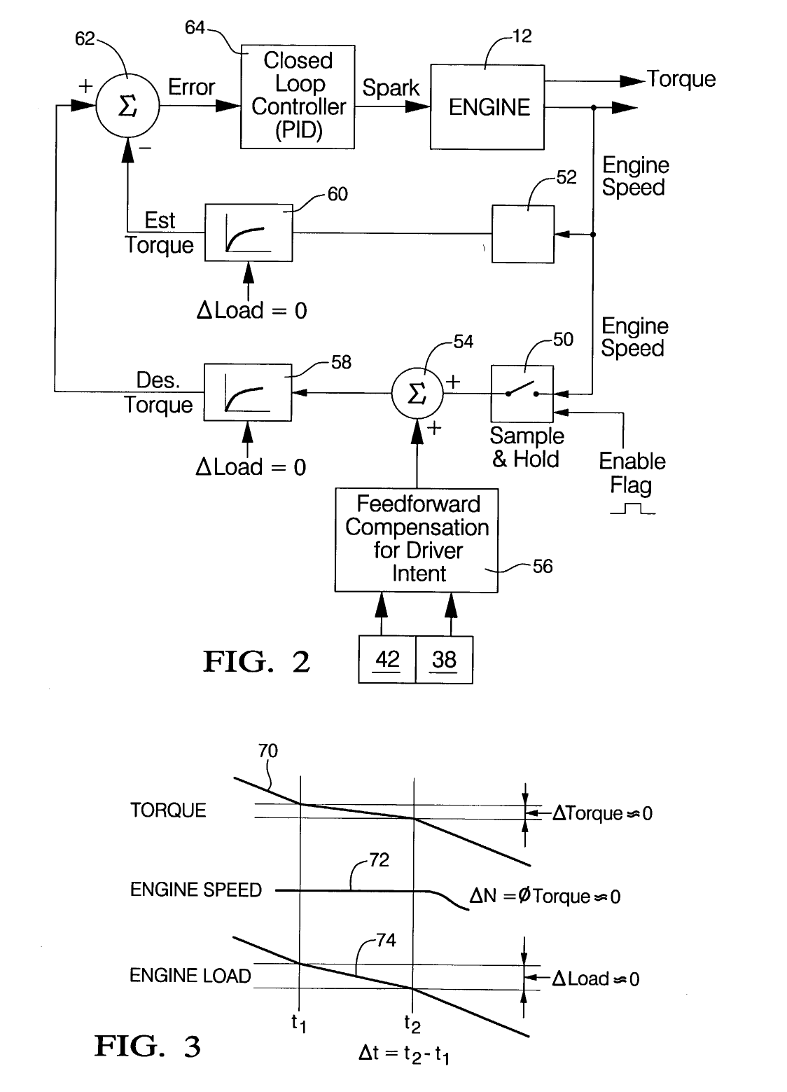

FIG. 2 is a control block diagram detailing a preferred embodiment of the present invention. The ICE 12 will vary its displacement in response to driving conditions and the control block of FIG. 2 will be enabled by a flag indicating the change in ICE 12 displacement at a sample hold block 50. The ICE 12 crankshaft speed will be determined by speed sensor 20 and fed to block 50 and block 52. Block 52 filters engine speed and block 50 samples and holds engine speed at the time the flag enables block 50. Summing junction 54 feeds-forward a signal for compensation for driver intent derived from the accelerator position pedal sensor 42 and/or the brake pedal sensor 38. The signal output from summing junction 54 and block 52 are transformed at blocks 58 and 60 with a table into an estimated and desired torque value. The estimated torque value and desired torque value are combined at summing junction 62 to generate an error value. The error value is processed by a closed loop control block 64 to generate a spark control output signal. The control block 64 is preferably a proportional integral control block, but may comprise any other form of control algorithm including other single input or single output compensators. The spark control output signal is output from the controller 18 to the spark controllers of the ignition system 16 to control torque using spark advance and retard during the deactivation and reactivation of cylinders 24.

FIG. 3 is a series of plots illustrating the accuracy of the torque signal using the present control system, over a short period of time (such as the previously-described two-second period). The engine torque is indirectly controlled using speed feedback to stay within an acceptable error band. Speed control of the engine torque is possible over this relatively short period of time since engine torque changes relatively slowly with reference

1. An engine control system in a vehicle comprising:
a variable displacement internal combustion engine;
a speed sensor for detecting the speed of said variable displacement internal combustion engine;
a controller for controlling the displacement of said variable displacement internal combustion engine; and
wherein said controller varies the spark timing of said variable displacement engine based upon the detected speed during changes in the displacement of said variable displacement internal combustion engine.

2. The engine control system of claim 1 wherein said controller advances the spark for a reactivation cylinder during a transition from deactivation to reactivation.

3. The engine control system of claim 1 wherein said controller retards the spark for a reactivation cylinder during a transition from deactivation to reactivation.

4. The engine control system of claim 1 wherein said speed sensor is a hall effect sensor.

5. The engine control system of claim 1 wherein said variable displacement internal combustion engine is an eight-cylinder engine.

6. The engine control system of claim 1 wherein said variable displacement internal combustion engine is an overhead valve engine.

7. The engine control system of claim 1 wherein said variable displacement internal combustion engine is an overhead cam engine.

8. A method of controlling the torque of a variable displacement internal combustion engine comprising the steps of:
detecting the speed of the variable displacement internal combustion engine; and
varying the spark timing of the variable displacement internal combustion engine during displacement changes.

9. The method of claim 8 wherein the step of varying the spark timing of the variable displacement internal combustion engine during displacement changes comprises advancing the spark for the cylinder upon reactivation.

10. The method of claim 8 wherein the step of varying the spark timing of the variable displacement internal combustion engine during displacement changes comprises retarding the spark for the cylinder upon reactivation.

11. A method of controlling the torque output of a variable displacement internal combustion engine comprising:
detecting the speed of the variable displacement internal combustion engine; and
controlling the engine speed of the variable displacement internal combustion engine based upon the detected engine speed during displacement changes of the variable displacement internal combustion engine.
